(19) United States
(12) Patent Application Publication
(10) Pub. No.: US 2003/0163922 A1
(43) Pub. Date: Sep. 4, 2003

(54) Folding scissors

(76) Inventors: Peter Ackeret, Kusnacht (CH); Pierre-Alain Jeandupeux, Delemont (CH); Yves Wira, Winkel (FR); Rolf Nussbaumer, Liesberg (CH); Claude Kottelat, Coux (CH)

Correspondence Address: Joseph F Hetz, Brinks Hofer Gilson & Lione, NBC Tower, Suite 3600, P O Box 10395, Chicago, IL, 60610, US

(21) Appl. No.: 10/311,781

(22) PCT Filed: Jul. 3, 2001
(86) PCT No.: PCT/EP01/07590

(30) Foreign Application Priority Data
Jul. 8, 2000 (DE) 100 33 393.1

(51) Int. Cl. B26B 13/00

(52) U.S. Cl. 30/255; 30/254

(57) ABSTRACT

The invention relates to swing-out scissors having two scissor blades (1, 2) and an actuating lever (4) which, arranged one beside the other, can be swung in and out, in relation to a housing (6), between a storage position and a use position, it being the case that, in the use position, one scissor blade (1) is fixed in relation to the housing (6) and the other scissor blade (2) can be closed by the actuating lever (4), counter to a spring force, via a driver (17), it being the case that a further driver (19) is provided, by means of which the actuating lever (4) and the moveable scissor blade (2) can be brought into operative connection in the use position, with the result that the moveable scissor blade (2) can be moved from the closed position into the open position via the actuating lever (4), the operative connection being interrupted when the scissors are swung in and out.

The invention relates to swing-out scissors according to the preamble of claims 1 and 12.

Such swing-out scissors for a multipurpose hand-held implement are known from WO 99/20438 and comprise two scissor blades and an actuating lever which, arranged one beside the other, can be swung in and out, in relation to a housing, between a storage position and a use position, it being the case that, in the use position, one scissor blade is fixed in relation to the housing and the other scissor blade can be closed by the actuating lever, counter to a spring force, via a driver.

In the case of such swing-out scissors, however, it is difficult to open the scissor blades if they have jammed during cutting since the actuating lever only acts in one direction but opening takes place by spring force, although this, in the case of jamming, for example by soiling, is not sufficient in order to open the scissor blades again. The scissor blades then have to be drawn apart from one another manually, although this is difficult.

The object of the invention is thus to provide swing-out scissors according to the preamble of claims 1 and 12 which make it possible for scissor blades which are jammed in the closed use position to be straightforwardly released from one another again.

This object is achieved according to the characterizing part of claims 1 and 12.

This makes it possible for jammed scissor blades to be released again by means of the actuating lever by the actuating lever being pivoted by a corresponding angle counter to its normal actuating direction for closing the scissor blades.

Further configurations of the invention can be gathered from the following description and the subclaims.

The invention is explained in more detail hereinbelow with reference to an exemplary embodiment illustrated in the attached figures, in which:

FIG. 1 shows a perspective view of swing-out scissors in the swung-out state with the scissor blades closed,

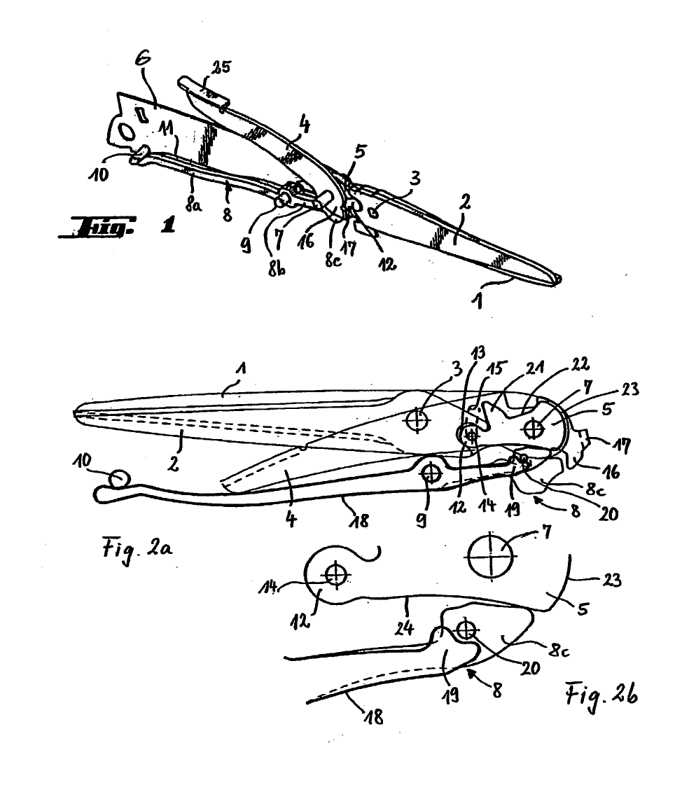

FIG. 2a shows a side view of swing-out scissors, which are slightly modified in relation to FIG. 1, in the swung-in state,

FIG. 2b shows an enlarged detail of FIG. 2a,

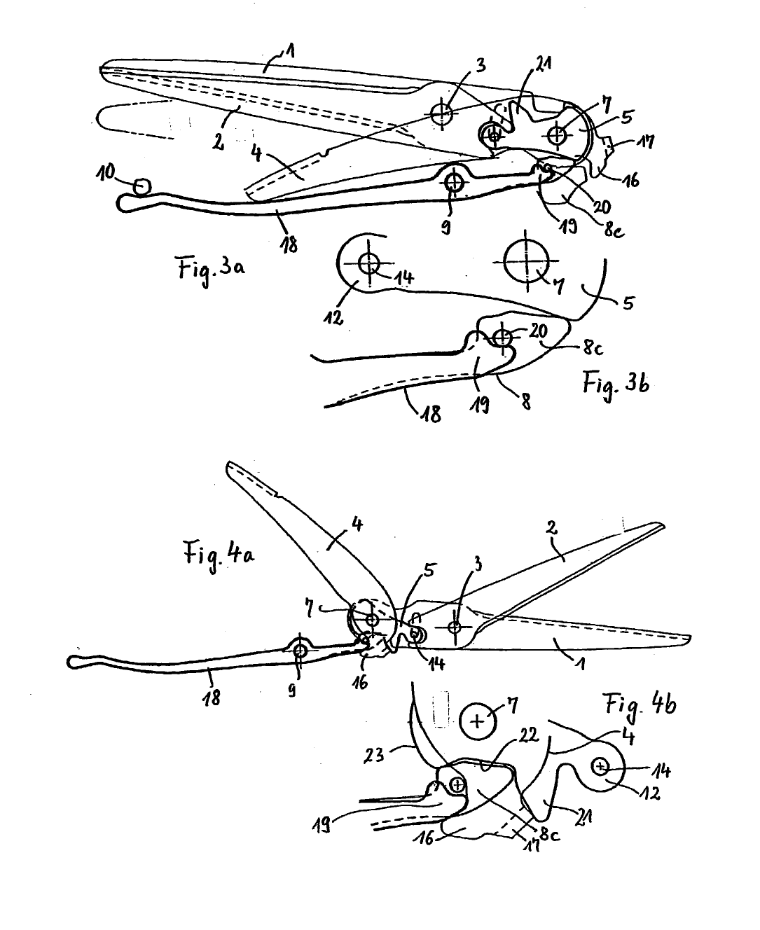

FIG. 3a shows the beginning of the operation of swinging out the swing-out scissors of FIG. 2a,

FIG. 3b shows an enlarged detail of FIG. 3a,

FIG. 4a shows the swing-out scissors of FIG. 2a in the open use state,

FIG. 4b shows an enlarged detail of FIG. 4a,

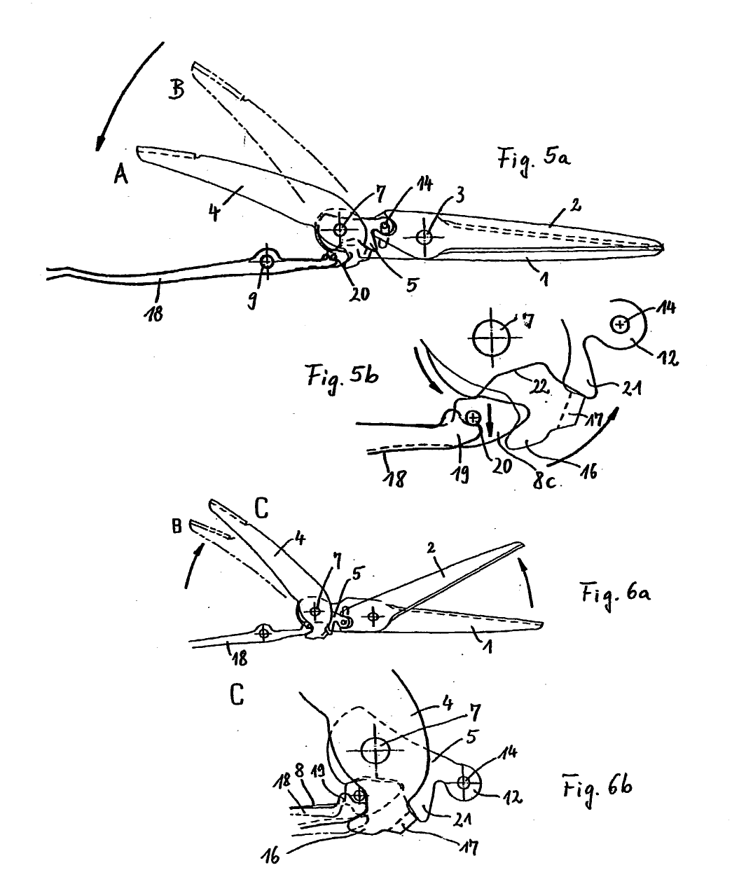

FIG. 5a shows the closed swing-out scissors of FIG. 2a in the use state,

FIG. 5b shows an enlarged detail of FIG. 5a,

FIG. 6a shows the swing-out scissors of FIG. 1 being opened by the jammed scissor blades being released, and

FIG. 6b shows a detail of FIG. 6a.

The swing-out scissors illustrated comprise two scissor blades 1, 2 which are connected to one another in an articulated manner via a rivet 3. The swing-out scissors also comprise an actuating lever 4 which engages with the scissor blade 2, which is moveable in the use position, via a movement-deflecting element 5. The scissor blade 1, which is blocked in the use position and thus fixed, the movement-deflecting element 5 and the actuating lever 4 are arranged in layers one beside the other such that they can be rotated on an axis pin 7 mounted in a housing 6 (only illustrated in part in the form of a plate) The movement-deflecting element 5 here is subjected to the action of a leaf spring 8 which is arranged on a pin 9, supported in the housing, and, by way of one leg 8a, which is directed away from the movement-deflecting element 5, is supported on a pin 10 in the housing 6 and, by way of a head 8c at the end of the other leg 8b, is in operative connection with the movement-deflecting element 5 in order, via the latter, for the moveable scissor blade 2, in the use position of the swing-out scissors, to be prestressed into the open position.

By means of a further leaf spring 11, which, like the leaf spring 8, is arranged on the pin 9 and is designed correspondingly, the fixed scissor blade 1 is blocked in the swung-out position by latching and is thus fixed in the use position.

The movement-deflecting element 5 has a circle-sector-shaped extension 12 which engages with a corresponding recess 13 at the shank end of the moveable scissor blade 2. As a result, when the movement-deflecting element 5 is rotated by the actuating lever 4 in the counter clockwise direction (of the illustrations), the moveable scissor blade 2 is moved into the closed position from its open position in relation to the fixed scissor blade 1.

The extension 12 bears a pin 14 which is accommodated by a circularly curved slot 15 on the fixed scissor blade 1, this determining the opening angle of the swing-out scissors.

The actuating lever 4 has an extension 16 which projects beyond the axis pin 7 and has a driver 17, which is bent over through 90° in the direction of the moveable scissor blade 2 and can be brought into engagement with the movement-deflecting element 5 in order to rotate the latter as well during pivoting of the actuating lever 4 for the purpose of closing the scissor blades 1, 2, and thus to pivot the moveable scissor blade 2. Since the movement-deflecting element 5 engages with the head 8c of the leaf spring 8, this actuation of the swing-out scissors involves deflection of the leaf spring 8, which guides said scissors back into the open position again when the actuating lever 4 is released.

Also provided, alongside the leaf spring 8, is an additional leaf spring 18 which, by way of one end, is likewise supported by the pin 10 on the housing 6, and can move about the pin 9, and, by way of the head 19 of its other end, is located adjacent to a pin 20, which projects from the head 8c of the leaf spring 8 and with which the additional leaf spring 18 can pass into operative connection.

As can be seen from FIGS. 2a and 2b, the pin 20, in the swung-in, storage position of the swing-action scissors, is disengaged from the head 19 of the additional leaf spring 18.

When the operation of swinging out the swing-out scissors begins, see FIGS. 3a and 3b, the moveable scissor blade 2 acts on the movement-deflecting element 5 and rotates the latter in accordance with the swing-out angle about the axis pin 7. The movement-deflecting element 5 acts on the head 8c of the leaf spring 8 and presses it inward, as a result of which the pin 20 engages with the head 19 of the additional leaf spring 18. Engagement, however, takes place as from a certain swing-out angle of, for example, 10°, in order that, up to a position in which the scissors can be easily gripped, the swing-out operation is not obstructed. At the same time, the scissor blade 1 acts on the leaf spring 11, which prestresses said blade into the swung-in position, the leaf spring thus likewise being deflected.

The beginning of the operation of swinging the swing-out scissors out of the housing 6 up to an angle which allows the scissor blades 1, 2 to be easily gripped, in order to be swung out fully by hand, may take place via a corresponding opening mechanism as is described, for example, in WO 99/20438. Upon completion of the swing-out operation, the actuating lever 4 is carried along via the driver 17, with the result that, finally, the use position illustrated in FIGS. 4a and 4b, with the scissor blades 1, 2 open, is reached.

In this fully swung-out state, in which the leaf spring 11 blocks the scissor blade 1 in relation to the housing 6, there is a certain amount of play between the head 19 of the additional leaf spring 18 and the pin 20, while a nose 21 of the movement-deflecting element 5, said nose serving for carrying along the actuating lever 4 from the swung-in position into the swung-out position via the driver 17, butts against said driver and, moreover, the extension 16, which bears the driver 17, butts against the head 19 of the additional leaf spring 18. In this position, the head 8c of the leaf spring 8 is accommodated in a corresponding recess 22 between the nose 21 and an essentially arcuate curved section 23 of the movement-deflecting element 5, said curved section merging into a section 24 which runs in a slightly concave manner to the extension 12 and, in the storage position, serves for prestressing the moveable scissor blade 2 into this position, see FIGS. 2a and 2b.

The swing-out scissors can then be actuated by virtue of the actuating lever 4 being pressed toward the housing 6, as a result of which the scissor blades 1, 2 are closed for cutting purposes, see FIGS. 5a and 5b. In this case, the movement-deflecting element 5 is also rotated about the axis pin 7 and presses the head 8c of the leaf spring 8 in the direction of the head 19 of the additional leaf spring, with the result that, finally, the pin 20 engages with the head 19 and thus subjects the additional leaf spring 18 to stressing as the closing movement continues. As a result, the force which is necessary for closing the scissor blades 1, 2 progressively increases toward the end of the closing operation, where the greatest possible spring force is necessary in order to unclamp the scissor blades 1, 2, this progressively increasing force providing for an agreeable cutting action of the scissors, while the cutting force is not increased by the additional leaf spring 18 over most of the closing displacement of the scissor blade 2.

The leaf springs 8, 18, which are subjected to stressing by the closure of the scissor blades 1, 2, normally result in the scissor blades 1, 2 being opened when the actuating lever 4 is released.

If, however, the two scissor blades 1, 2 have jammed, despite the leaf springs 8, 18 being subjected to stressing, it is sufficient for the actuating lever 4, which is then freely moveable between its position A corresponding to the closed scissor blades 1, 2 and its position B, in which the extension 16 is positioned against the head 19, to be pivoted away from the housing 6, via its position B, into the position C according to FIGS. 6a and 6b in order to release the scissor blades 1, 2 again, with the result that these can be moved back into the open position. By virtue of this pivoting action, the extension 16 on the actuating lever 4 carries along the head 19 of the additional leaf spring 18 in the direction of the pin 20, as a result of which this and thus the head 8c of the leaf spring 8 are moved correspondingly and, consequently, the movement-deflecting element 5, which accommodates the head 8c of the leaf spring 8 in the recess 22, is rotated into the position illustrated in FIG. 6b. The moveable scissor blade 2 is thus forcibly unclamped via the movement-deflecting element 5 and passes once again into the open position in relation to the fixed scissor blade 1.

In order to swing in the swing-out scissors, the scissor blade 1, which is fixed in the use position, is unblocked by means of a separate mechanism (not illustrated) and pivoted in the direction of the housing 6 counter to the force of the leaf spring 11, as a result of which, via the rivet 3 and the pin 14, the moveable scissor blade 2 and the movement-deflecting element 5 are also swung in as well. The two scissor blades 1, 2 here strike against a thumb notch 25, which projects into the movement path of the scissor blades and belongs to the actuating lever 4, as a result of which the latter is also swung in as well and retained beneath the two scissor blades 1, 2, FIG. 2a. The fixed scissor blade 1 here is prestressed into the storage position by the leaf spring 11, while the movement-deflecting element 5 is moved by the leaf spring 8 until the pin 14 is positioned against the end of the slot 15 and, in this position, secures the moveable scissor blade 2 in the closed position.

It is indeed also possible to use one appropriately thick leaf spring instead of the two leaf springs 8, 18. In order to achieve large spring forces, however, it is expedient to use two leaf springs 8, 18 since leaf springs of the type required here can only be produced by punching up to a certain thickness, but the spring force then achieved would be correspondingly limited. In addition, the use of two leaf springs 8, 18 provides the advantage that the force of the additional leaf spring 18 is not active in all positions of the scissors.

The actuating lever 5 may also be coupled directly to the moveable scissor blade 2, its driver 17 acting thereon in order to close the scissor blades 1, 2, as a result of which there is no need for any movement-deflecting element 5. In this case, it is then necessary to provide a further driver, by means of which the actuating lever 4 and the moveable scissor blade 2 can be brought into operative connection in the use position, with the result that the moveable scissor blade 2 can be moved from the closed position into the open position via the actuating lever 4, the operative connection being interrupted when the scissors are swung in and out, i.e. the further driver is only active in a direction of rotation of the actuating lever 4 which is directed counter to the direction of rotation for closing the scissor blades 1, 2.

1. Swing-out scissors having two scissor blades (1, 2) and an actuating lever (4) which, arranged one beside the other, can be swung in and out, in relation to a housing (6), between a storage position and a use position, it being the case that, in the use position, one scissor blade (1) is fixed in relation to the housing (6) and the other, moveable scissor blade (2) can be closed by the actuating lever (4), counter to a spring force, via a driver (17), characterized in that a further driver (19) is provided, by means of which the actuating lever (4) and the moveable scissor blade (2) can be brought into operative connection in the use position, with the result that the moveable scissor blade (2) can be moved from the closed position into the open position via the actuating lever (4), the operative connection being interrupted when the scissors are swung in and out.

2. The swing-out scissors as claimed in claim 1, characterized in that the further driver (19) is resiliently moveable.

3. The swing-out scissors as claimed in claim 1 or 2, characterized in that the operative connection is formfitting.

4. The swing-out scissors as claimed in one of claims 1 to 3, characterized in that the operative connection can be interrupted by the scissors being swung in and out.

5. The swing-out scissors as claimed in one of claims 1 to 4, characterized in that the moveable scissor blade (2), in the use position, is prestressed into the open position by a spring (8), and the further driver (19) acts on the moveable scissor blade (2) via the spring (8).

6. The swing-out scissors as claimed in claim 5, characterized in that the spring (8, 18) is designed as a leaf spring, onto which the further driver (19) can be pressed.

7. The swing-out scissors as claimed in one of claims 1 to 6, characterized in that the further driver (19) can be brought into operative connection with the moveable scissor blade (2) via a movement-deflecting element (5) for the latter.

8. The swing-out scissors as claimed in claim 6 or 7, characterized in that two leaf springs (8, 18) are arranged one beside the other, it being possible for the head (19) of one leaf spring (18) to be brought into engagement with a pin (20) on the head (8c) of the other leaf spring (8).

9. The swing-out scissors as claimed in claim 8, characterized in that the head (19) has a certain amount of play in relation to the pin (20) in the, storage position and/or in the open position of the scissor blades (1, 2) in the use position.

10. The swing-out scissors as claimed in one of claims 1 to 9, characterized in that an extension (16) is arranged on the actuating lever (4), it being possible for the further driver (19) to be moved via said extension.

11. The swing-out scissors as claimed in claim 10, characterized in that the extension (16) bears the driver (17) for the moveable scissor blade (2).

12. Swing-out scissors having two scissor blades (1, 2) and an actuating lever (4) which, arranged one beside the other, can be swung in and out, in relation to a housing (6), between a storage position and a use position, it being the case that, in the use position, one scissor blade (1) is fixed in relation to the housing (6) and the other, moveable scissor blade (2) can be closed by the actuating lever (4), counter to a spring force, via a driver (17), in particular as claimed in one of claims 1 to 11, characterized in that the moveable scissor blade (2) may be subjected to the action of two separate springs (8, 18), one spring (18) only being active in predetermined swung-out or angled positions of the two scissor blades (1, 2) in relation to one another.

13. The swing-out scissors as claimed in claim 12, characterized in that the two springs (8, 18) are designed as leaf springs and arranged parallel one beside the other.

14. The swing-out scissors as claimed in claim 13, characterized in that the head (19) of one leaf spring (18) engages with a pin (20) on the head (8c) of the other leaf spring (8).

15. The swing-out scissors as claimed in claim 14, characterized in that the head (19) has a certain amount of play in relation to the pin (20) in the storage position and/or in the open position of the scissor blades (1, 2) in the use position.
